(19) United States
(12) Patent Application Publication
(10) Pub. No.: US 2020/0192539 A1
(43) Pub. Date: Jun. 18, 2020

(54) SYSTEM AND METHOD FOR OPERATING SYSTEM EVENT REDIRECTION

(71) Applicant: VMware, Inc., Palo Alto, CA (US)

(72) Inventors: Zhao LI, Beijing (CN); Bo Steven LIU, Beijing (CN); Qi SUN, Beijing (CN); Li HUANG, Beijing (CN); Feng YAN, Beijing (CN); Kun SHI, Beijing (CN); Yingfeng OU, Beijing (CN); Mingsheng ZANG, Beijing (CN)

(21) Appl. No.: 16/444,840

(22) Filed: Jun. 18, 2019

Related U.S. Application Data
(60) Provisional application No. 62/779,257, filed on Dec. 13, 2018.

(51) Int. Cl. G06F 3/0486; H04L 29/08; G06F 3/0484; G06F 9/451; G06F 9/455

(52) U.S. Cl. CPC G06F 3/0486; H04L 67/06; H04L 67/08; G06F 2009/45595; G06F 9/452; G06F 9/45558; G06F 3/04845

(57) ABSTRACT

The disclosure provides an approach for transferring an object between a virtualized desktop infrastructure (VDI) client running on a client device and a remote virtual machine (VM) connected to the VDI client through a network. The method includes receiving, at the client device, an input corresponding to a drag and drop operation of an object between the client device and a remote desktop displayed at the client device, the remote desktop running on the remote VM. The method includes transferring one or more commands corresponding to the drag and drop operation from the client device to the remote VM or from the remote VM to the client device via a first channel. The method also includes transferring the object from the client device to the remote VM or from the remote VM to the client device via a second channel.

### CROSS-REFERENCE TO RELATED APPLICATIONS

This application claims priority to U.S. provisional application having Ser. No. 62/779,257, filed on Dec. 13, 2018, which is hereby incorporated by reference herein in its entirety.

### BACKGROUND

In a virtual desktop infrastructure (VDI) environment, objects such as plain text and images can be shared between a local client device and a remote desktop or remote application running on a remote device and displayed at the local client device by using a clipboard feature (i.e., copy and paste), meaning the objects are shared between the local client device and the remote device. In order to copy files or folders between a local client device and a remote desktop or application of a remote device displayed at the local client device, a client drive redirection (CDR) feature is used, which may require multiple steps to transfer the file between the local client device and the remote device. The user experience would be improved with a simpler system for copying files and/or folders between the local client device and the remote device. Therefore what is needed is an improved method for a user to share files and/or folders between a local client device and a remote desktop or application of the remote device.

In addition to sharing files and/or folders, users may wish to share data of different formats between a local client device and a remote desktop application. If it's possible to share data of different formats, users and/or administrators may also wish to implement rules to manage sharing for the different formats. Users may also want to use client devices with different operating systems than the operating system installed on the remote device. These features are not found in current VDI environments, and therefore what are needed are systems and methods for implementing these features.

### SUMMARY

A method of transferring a file or other object between a virtualized desktop infrastructure (VDI) client running on a client device and a remote virtual machine (VM), wherein the remote VM is connected to the VDI client through a network. The method includes receiving, at the client device, an input corresponding to a drag and drop operation of an object between a local storage of the client device and a remote desktop displayed at the client device, the remote desktop running on the remote VM. The method also includes, based on the input, transferring one or more commands corresponding to the drag and drop operation from the client device to the remote VM or from the remote VM to the client device via a first channel. The method also includes, based on the input, transferring the object from the client device to the remote VM or from the remote VM to the client device via a second channel.

Further embodiments include a non-transitory computer-readable storage medium storing instructions that, when executed by a computer system, cause the computer system to perform the method set forth above.

### BRIEF DESCRIPTION OF THE DRAWINGS

FIG. 1 depicts a block diagram of a virtualized desktop infrastructure system in which one or more embodiments of the present invention may be implemented.

FIGS. 2A and 2B depict a workflow diagram for transferring drag and drop commands using a first channel and a second channel.

FIG. 3 depicts a workflow diagram for transferring a dragged file or folder using a CDR channel.

FIG. 4 depicts a method for transferring a file or folder from a client to an agent using a temporary folder.

FIG. 5 depicts a method for transferring a file or folder from an agent to a client using a temporary folder.

FIG. 6 depicts a method for transferring a file or folder from a client to an agent without using a temporary folder.

FIG. 7 depicts a method for transferring a file or folder from an agent to a client without using a temporary folder.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for operating system (OS) event redirection. By using OS event redirection, a “drag and drop” (DnD) user experience can be implemented that allows files and/or folders to be shared between a local client device and a remote desktop or application of a remote device. DnD is a common feature where a user “grabs” a representation of an object (such as a file) and drags it to a different location using a user interface (UI). For example, the UI represents a file system that allows a representation of an object to be dragged from a portion of the UI representing one location in the file system to another portion of the UI representing another location in the file system. Underlying software, such as an operating system (OS), correspondingly transfers the object from the one location to the other location. In certain embodiments, the UI further allows an object to be dragged from a local storage of a local client device to a remote desktop or application of a remote device displayed at the local client device. For example, a representation of the object can be dragged to the displayed remote desktop or application at the local client device. OS event redirection causes the object to be transferred (e.g., copied) from the local client device to the remote device for access by the remote desktop or application. With OS event redirection, users can conveniently drag and drop files, folders, or other objects between local and remote devices using logical or virtual channels configured on one or more physical interfaces. Different virtual channels can have different latencies or bandwidths, due to the channels being allocated different resources of the one or more physical interfaces, which makes some channels more suitable for certain operations than other channels. Two virtual channels can be leveraged to implement OS event redirection. Using multiple channels allows commands to be transferred on a different channel than the dragged objects. Therefore if large objects are dragged and dropped, requiring a long time for the transfer to complete, the transfer does not interfere with commands because the commands are on a separate channel. First, in one embodiment, a first channel is used to transfer the DnD workflow commands between the local and remote devices, such as a control message channel. Then, a second channel is used to transfer the dragged files, such as a CDR channel. The CDR channel can be a high-speed channel so that the dragged objects are transferred more quickly. OS event redirection also allows the remote desktop or application side of the remote device to simulate an OS event to make the OS event look like the event is happening locally at the local client device. In another embodiment, the channel used to transfer the DnD workflow commands is also used to transfer the dragged object or files. In other embodiments, size and/or format controls are implemented on the dragged objects or files.

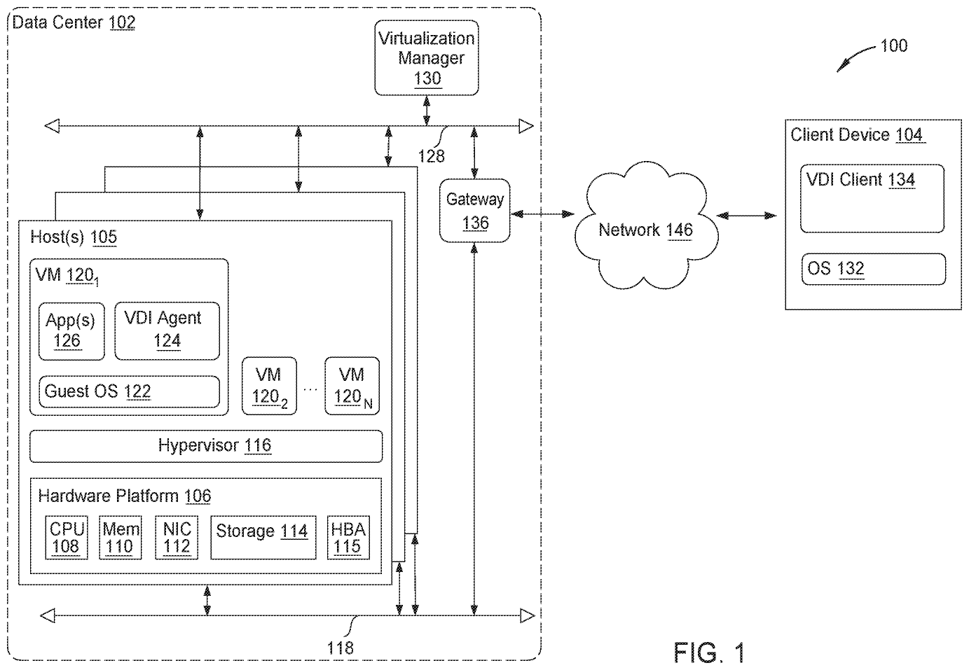

FIG. 1 depicts a block diagram of a virtualized desktop infrastructure (VDI) system 100 in which one or more embodiments of the present invention may be implemented. VDI system 100 comprises at least one client device 104 and a data center 102, connected by a network 146. Network 146 may be, for example, a direct link, a local area network (LAN), a wide area network (WAN) such as the Internet, another type of network, or a combination of these.

Client device 104 is a physical device, such as a general purpose desktop computer or mobile computer. A mobile computer may be, for example, a laptop, a mobile phone, or a tablet computer. Client device 104 includes VDI client 134 and OS 132, with VDI client 134 running on top of OS 132. OS 132 may be a standard, commodity operating system.

VDI client 134 is a user-side interface of a virtualized desktop running on one of virtual machines (VMs) 120. As used herein, a “virtualized desktop” or “remote desktop” is a desktop running on one of VMs 120 that is displayed remotely on client device 104, as though the remote desktop were running on client device 104. By opening VDI client 134, a user of client device 104 accesses, through network 146, a remote desktop running in remote data center 102, from any location, using client device 104. Frames of the remote desktop running on VM 120 are transmitted to VDI client 134 at a certain frame rate using a desktop delivery protocol such as VMware® Blast™, or Microsoft® Remote Desktop Protocol (RDP)™.

After transmission, the frames are displayed on client device 104 for interaction by the user. Client device 104 sends user inputs to VM 120 for processing on VM 120 of data center 102, taking processing load off of client device 104. Such centralized and automated management of remote desktops provides increased control and cost savings. VDI client 134 may be, for example, VMware® View™, or a special purpose thin client such as those available from Dell, HP, NEC, Sun Microsystems, Wyse, and others.

Data center 102 includes host(s) 105, a virtualization manager 130, a gateway 136, a management network 128, and a data network 118. Although the management and data network are shown as separate physical networks, it is also possible in some implementations to logically isolate the management network from the data network using different VLAN identifiers. Each of hosts 105 may be constructed on a server grade hardware platform 106, such as an x86 architecture platform. For example, hosts 105 may be geographically co-located servers on the same rack.

Host 105 is configured to provide a virtualization layer, also referred to as a hypervisor 116, that abstracts processor, memory, storage, and networking resources of hardware platform 106 into multiple VMs 120₁ to 120_{N} (collectively referred to as VMs 120 and individually referred to as VM 120) that run concurrently on the same host. Hypervisor 116 may run on top of the operating system in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. In some implementations, the hypervisor may comprise system level software as well as a “Domain 0” or “Root Partition” virtual machine, which is a privileged machine that has access to the physical hardware resources of the host. In this implementation, one or more of a virtual switch, virtual tunnel endpoint (VTEP), etc., along with hardware drivers, may reside in the privileged virtual machine. Although the disclosure is described with reference to VMs, the teachings herein also apply to other types of virtual computing instances (VCIs), such as containers, Docker containers, data compute nodes, isolated user space instances, namespace containers, and the like. In certain embodiments, VMs 120 may be containers that run on host 105 without the use of a hypervisor. One example of a hypervisor 116 that may be used is a VMware ESXi™ hypervisor provided as part of the VMware vSphere® solution made commercially available from VMware, Inc. of Palo Alto, Calif.

Each VM 120 includes a guest OS 122, one or more applications 126, and a VDI agent 124. Application(s) 126 and VDI agent 124 run on top of guest OS 122. Guest OS 122 may be a standard, commodity operating system. An application 126 may be any software program, such as a word processing program.

VDI agent 124 is a desktop virtualization program that connects to VDI client 134 of client device 104, through network 146. The connection between VDI agent 124 and VDI client 134 may be authenticated, such as through a username and password combination pertaining to client device 104 or to a user of client device 104. VDI agent 124 transmits, to VDI client 134, image frames of the remote desktop running on VM 120 that contains VDI agent 124. An image frame includes information on appearance of the remote desktop running on VM 120, and that information includes pixel color and location information. In addition to an image frame, VDI agent 124 may also transmit metadata of that frame to VDI client 134. The metadata may include x and y coordinate locations of a mouse cursor, x and y coordinates and size of windows of application(s) 126 open on the remote desktop, which application(s) 126 are running on and/or displayed on the remote desktop of VM 120, and other information.

Hardware platform 106 of each host 105 includes components of a computing device such as one or more processors (CPUs) 108, system memory 110, a network interface 112, storage system 114, a host bus adapter (HBA) 115, and other I/O devices such as, for example, a mouse and keyboard (not shown). CPU 108 is configured to execute instructions, for example, executable instructions that perform one or more operations described herein and that may be stored in memory 110 and in storage 114. Network interface 112 enables host 105 to communicate with other devices via a communication medium, such as network 118 or network 128. Network interface 112 may include one or more network adapters, also referred to as Network Interface Cards (NICs). Storage system 114 represents persistent storage devices (e.g., one or more hard disks, flash memory modules, solid state disks, and/or optical disks). Host bus adapter (HBA) couples host 105 to one or more external storages (not shown), such as a storage area network (SAN). Other external storages that may be used include network-attached storage (NAS) and other network data storage systems, which may be accessible via NIC 112.

System memory 110 is hardware allowing information, such as executable instructions, configurations, and other data, to be stored and retrieved. Memory 110 is where programs and data are kept when CPU 108 is actively using them. Memory 110 may be volatile memory or non-volatile memory. Volatile or non-persistent memory is memory that needs constant power in order to prevent data from being erased. Volatile memory describes conventional memory, such as dynamic random access memory (DRAM). Non-volatile memory is memory that is persistent (non-volatile). Non-volatile memory is memory that retains its data after having power cycled (turned off and then back on). Non-volatile memory is byte-addressable, random access non-volatile memory.

Virtualization manager 130 communicates with hosts 105 via a network, shown as a management network 128, and carries out administrative tasks for data center 102 such as managing hosts 105, managing VMs 120 running within each host 105, provisioning VMs, migrating VMs from one host to another host, and load balancing between hosts 105. Virtualization manager 130 may be a computer program that resides and executes in a central server in data center 102 or, alternatively, virtualization manager 130 may run as a virtual appliance (e.g., a VM) in one of hosts 105. One example of a virtualization manager is the vCenter Server™ product made available from VMware, Inc.

Gateway 136 provides VMs 120 and other components in data center 102 with connectivity to network 146. Gateway 136 may manage external public IP addresses for VMs 120, route traffic incoming to and outgoing from data center 102, and provide networking services, such as firewalls, network address translation (NAT), dynamic host configuration protocol (DHCP), and load balancing. Gateway 136 uses data network 118 to transmit data network packets to hosts 105. Gateway 136 may be a virtual computing instance, a physical device, or a software module running within host 105. Gateway 136 may include two gateways: a management gateway for management network 128 and a data gateway for data network 118.

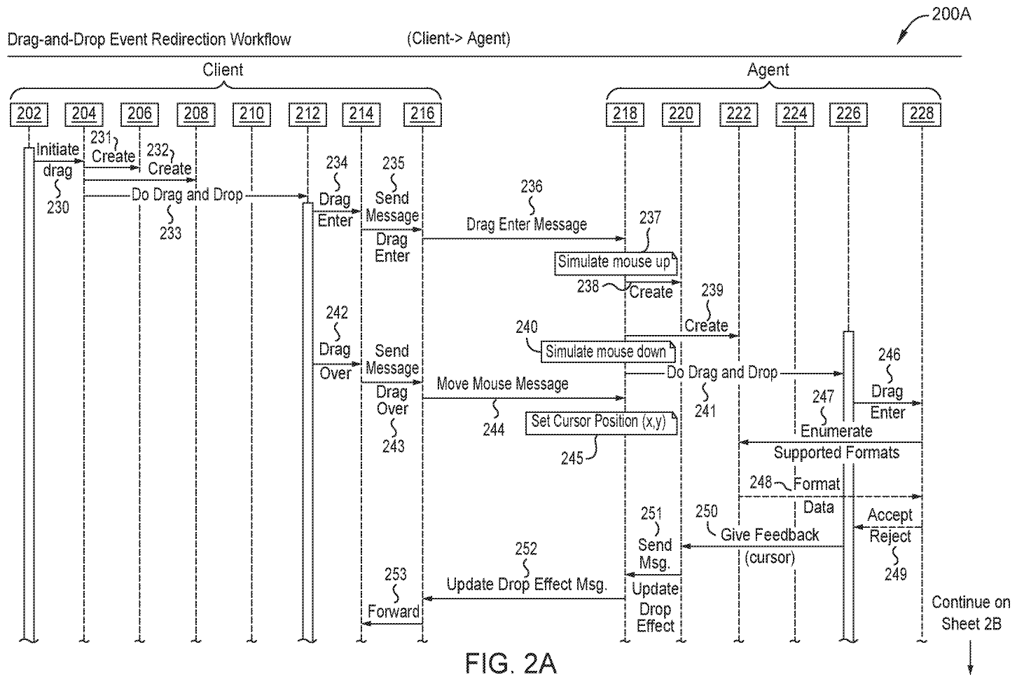

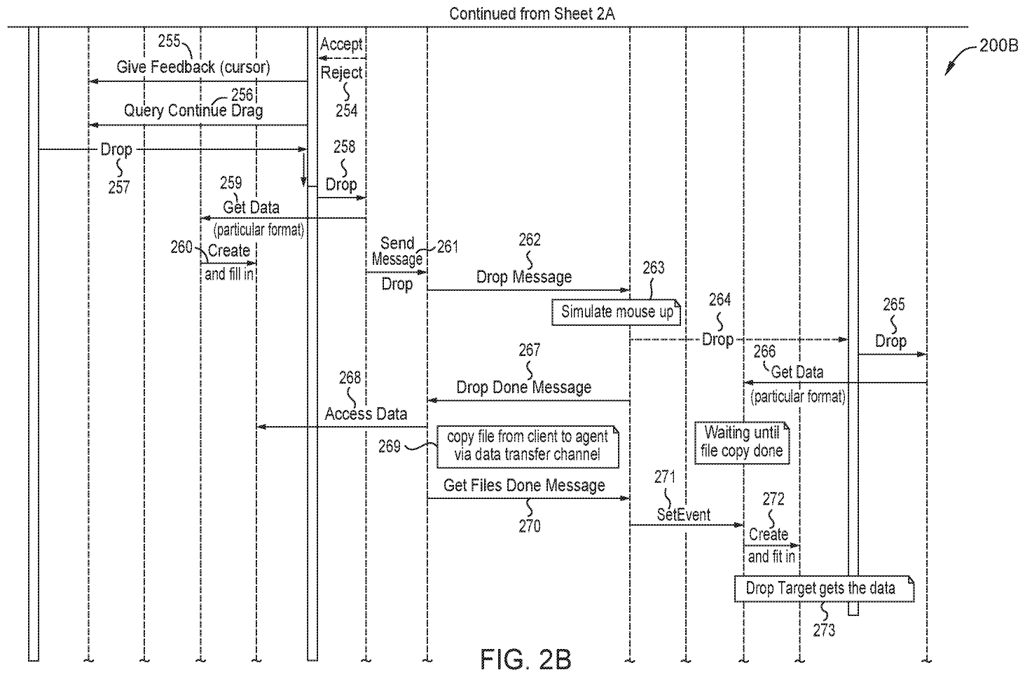

FIGS. 2A and 2B depict a workflow diagram 200 for transferring DnD commands using a first virtual channel and a second virtual channel. In one example embodiment, this first channel is a control message virtual channel. Diagrams 200A and 200B illustrate a user 202 that implements a drag and drop operation by performing drag and drop functions with an input device such as a mouse, touch-screen, etc., of a client device, such as client device 104. The actions performed on the client side shown as performed by elements 202-216 are illustrated on the left side of diagram 200 and may be performed by VDI client 134 and/or OS 132 running on client device 104 of FIG. 1, while the actions performed on the agent or remote side shown as performed by elements 218-228 are illustrated on the right side of diagram 200 and may be performed by VDI agent 124, Apps 126, and/or Guest OS 122 running on host 105 of FIG. 1. In certain embodiments, DnD operations are facilitated with Object Linking and Embedding (OLE). OLE is a Microsoft® technology that facilitates the sharing of application data and objects written in different formats from multiple sources. OLE is used for DnD and clipboard operations. OLE creates data sources and objects that the operating system uses to perform these operations. An OLE implementation performs DnD operations by creating a DnD data object 208 corresponding to the object being dragged, a DnD drop source object 206, and a DnD drop target object 214 on the client side. OLE also creates objects on the agent side, which includes DnD drop source 220, DnD data object 222, and DnD drop target 228. The use of these OLE objects in an example operation is described in further detail below. Though certain aspects are described with respect to OLE of OS 132, it should be understood that other technologies may similarly be used for other types of OS.

In this example, a user 202 at client device 104 uses the mouse to select, using a UI, representations of one or more files or folders stored locally at the client device 104 by holding down the mouse on the selected representations of the one or more files or folders. The user then drags the selected representations with the mouse to a portion of the UI displayed at the client device 104 displaying a remote desktop or remote application of VM 120 and drops the representations of the selected one or more files or folders at the remote desktop or application by releasing the mouse. The files or folders are then transmitted to the remote device, e.g., host 105, from the client device 104 for access by the remote desktop or application on VM 120. With the embodiments described herein, and from the perspective of the user, the experience for dragging and dropping local files/folders on the client side to a remote desktop or application is the same as local drag and drop within a client device.

The method illustrated in FIGS. 2A and 2B operates as follows. The method begins in FIG. 2A where a user 202 initiates a drag at step 230 in a source application 204 (e.g., VDI client 134) on the client side. For example, a user 202 selects a file with a mouse and then drags the file (e.g., as represented in a file system) stored locally with respect to client device 104 using a UI provided by OS 132 of client device 104 to a virtual desktop of VM 120 on host 105 displayed at client device 104 by VDI client 134. OLE in OS 132 creates DnD Drop Source 206 at step 231. DnD Data Object 208 is created by OLE in OS 132 at step 232. DnD Data Object 208 enables data transfer and notification of changes in data. For a file or folder, DnD Data Object 208 holds the file paths. For other data formats (like image or text), DnD Data Object 208 holds the data itself. A Do drag and drop operation is called at step 233 to VDI client 134 to begin a drag and drop operation. OS DnD Interface 212 in OS 132 is an OLE function that handles DnD interactions between applications and the OS. OS DnD Interface 212 receives the Do drag and drop operation and a Drag Enter is sent in step 234 to DnD Drop Target 214, which is an object also created by OLE for facilitating DnD operations. At step 235, Drag Enter message is sent from DnD Drop Target 214 to Target App/Remote Desktop 216 at VDI client 134.

To continue the DnD operation, a Drag Enter message 236 is sent from the client side to DnD Server 218 in guest OS 122 at VM 120 on the remote side. At step 237 a detection window is moved and a mouse up action is simulated to simulate the drag event on the remote desktop. At step 238 OLE creates a mirror DnD Drop Source 220 object on the remote side at VM 120. A mirror DnD Data Object interface 222 on the remote side is created by OLE in step 239. At step 240 the DnD Server 218 in guest OS 122 simulates a mouse down action. OS DnD Interface 226 in guest OS 122 receives the Do drag and drop operation 241.

On the client side, at OS 132, a Drag Over event 242 occurs and a Drag Over Message is sent at step 243 from DnD Drop Target 214 to Target App/Remote Desktop 216 at client device 104. In one example embodiment, an icon is displayed to the user 202 on client device 104 to inform the user whether the dragged object can be dragged to a specific location. That is, a user may see an icon like a plus sign (+) if the user is allowed to drag the object to a certain location. If the user cannot drag the object to that location, the user may see a different icon, such as an X. A Move Mouse message 244 is transmitted from OS 132 on the client side to the DnD Server 218 on the remote side. Move Mouse message 244 redirects the Drag Over event 242 to the remote side. DnD Server 218 sets a cursor position on a user interface representing guest OS 122 at step 245. A Drag Enter message 246 is sent from OS DnD Interface 226 in guest OS 122 to DnD Drop Target 228. DnD Drop Target 228 is on OLE object used for drag and drop operations on the remote side. DnD Drop Target 228 enumerates the format in which data is stored in DnD Data Object 222 at steps 247 and 248, and an accept or reject message 249 is generated on the remote side. This message 249 instructs client device 104 as to whether the remote side accepts or rejects the drag event.

Feedback to user 202 is sent from the remote side to the client side. OS DnD Interface 226 on the remote side sends a Give Feedback message 250 to DnD Drop Source 220, which sends an Update Drop Effect message 251 to DnD Server 218 in guest OS 122. An Update Drop Effect Message 252 is transmitted to client device 104. An accept or reject message is forwarded at steps 253 and 254 to OS DnD Interface 212 in OS 132 on the client side. Step 254 and later steps are illustrated on FIG. 2B. Cursor feedback 255 is transmitted to source app 204 at OS 132 of client device 104 to display the cursor position to the user, while a Query Continue Drag 256 is sent to determine if a drag continues on the client side (i.e., to determine if the user has completed the drag operation and “dropped” the dragged object).

User 202 then performs a drop action 257. The drop action can be performed by the user releasing a mouse button once the user 202 has dragged the selected file or folder to the target location. OS DnD Interface 212 in OS 132 transmits the drop action to DnD Drop Target 214 at step 258. DnD Drop Target 214 receives data regarding the dragged object (in particular, the format of the object) from DnD Data Object 208 at step 259 and the actual data content is retrieved at step 260 with the use of OS Medium Exchange 210 to retrieve the data from the disk. At step 261, a Drop message is sent to Target App 216.

The Drop message 262 is then transmitted from the client side to the remote side. A mouse up operation is simulated in guest OS 122 on the remote side at step 263. The Drop Message is then transmitted to OS DnD Interface 226 in guest OS 122 at step 264, and then sent to DnD Drop Target 228 at step 265. A Get Data message is sent at step 266 from DnD Drop Target 228 to retrieve data from DnD Data Object 222.

A Drop Done message 267 is transmitted from guest OS 122 at the remote side to OS 132 at the client side. Target pp 216 in OS 132 accesses the dragged object's data on disk from OS Medium Exchange 210 at step 268. At step 269, the file or other dragged object is copied from the client side to the remote side via a second channel, such as the CDR channel in one embodiment. The remote side waits until the copy operation is complete. When the copy operation is finished, a Get Files Done message 270 is transmitted from the client side to the remote side. A Set Event message 271 is sent from DnD Server 218 in guest OS 122 to DnD Data Object 222. Data content of the transferred object is retrieved from OS Medium Exchange 224 at step 272, and DnD Drop Target 228 receives the dragged and dropped file at step 273.

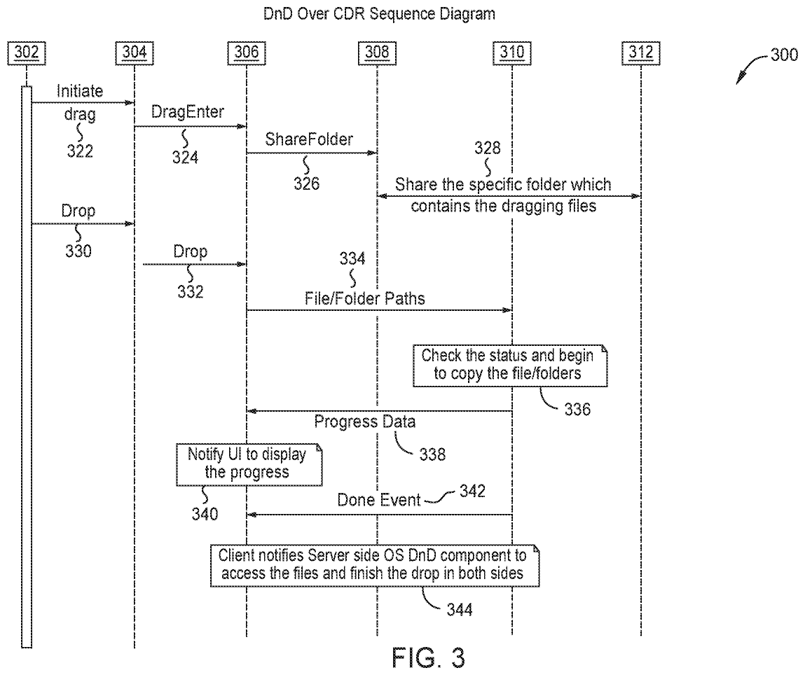

FIG. 3 is a workflow diagram 300 for transferring a dragged file, folder, or other object using a client drive redirection (CDR) channel. When dragging a file from client device 104 to an agent, such as VDI agent 124, the folder containing the dragged file is shared to the agent. When dragging a file from agent to client, a temporary folder is created on the client side and shared to the agent as the drop target folder. The actions in FIG. 3 may be performed by VDI client 134 and/or OS 132 running on client device 104 of FIG. 1, or may be performed by VDI agent 124, Apps 126, and/or Guest OS 122 running on host 105 of FIG. 1, depending on the direction the file is dragged. In this example, the user drags an object from client device 104 to a remote desktop of VM 120. A user 302 initiates a drag at step 322 by selecting a file or folder at client device 104 by clicking and holding a mouse button, for example. A DragEnter event 324 is transmitted from OS DND Interface 304 in OS 132 to DND Client 306 in OS 132. At step 326 the folder containing the dragged object is shared from DnD Client 306 to CDR Client 308 in OS 132.

At step 328, the folder that contains the dragged objects is shared between CDR Client 308 and CDR Server 312 in guest OS 122. Then, when user 302 has dragged the files to the desired destination at the remote desktop of VM 120, user 302 drops the files at step 330. The drop notification is transmitted to DnD Client 306 from OS DnD Interface 304 at step 332. File and/or folder paths are transmitted to a DnD Server 310 in guest OS 122 via step 334. Then, the copy process for the files and/or folders begins at step 336.

During the copy process, progress data is communicated from the remote side to client device 104 so user 302 can view the copy progress. This progress data, as shown, is transmitted from DnD Server 310 at the remote side to DnD Client 306 at step 338. At step 340, the client user interface (UI) is notified to display the progress to user 302 at client device 104.

When the file transfer is finished, a Done Event message is generated at DnD Server 310 at the remote side and transmitted to DnD Client 306 in OS 132 at step 342. Then, at step 344 the client uses a DnD remote procedure call (RPC) to notify the server side OS DnD component to access the files and finish the drop operation. In some embodiments, the dragged file is first copied to a temporary folder on the remote side. Then, after the copy is complete, the file is copied from the temporary folder to the actual destination folder. In other embodiments, the dragged file is copied directly to the actual destination without using a temporary folder.

Three example methods are illustrated to show the progress window to the user at client device 104. A first method is to display the progress window using an RMKS (remote mouse, keyboard, screen) process. An advantage of this solution is that it is simple to implement when a new platform is supported in VDI. A second method is to display the progress window in a client process in OS 132 at client device 104. This method provides a flexible solution to showing the progress in the user interface at the client device 104. A third method is to manage the copy progress window on the remote side in guest OS 122. With this third method, the client side only needs to display a simple window at client device 104, such as part of the remote desktop frames, and there is limited communication needed between the client and agent side. However, the third method may be a more complex implementation in some embodiments.

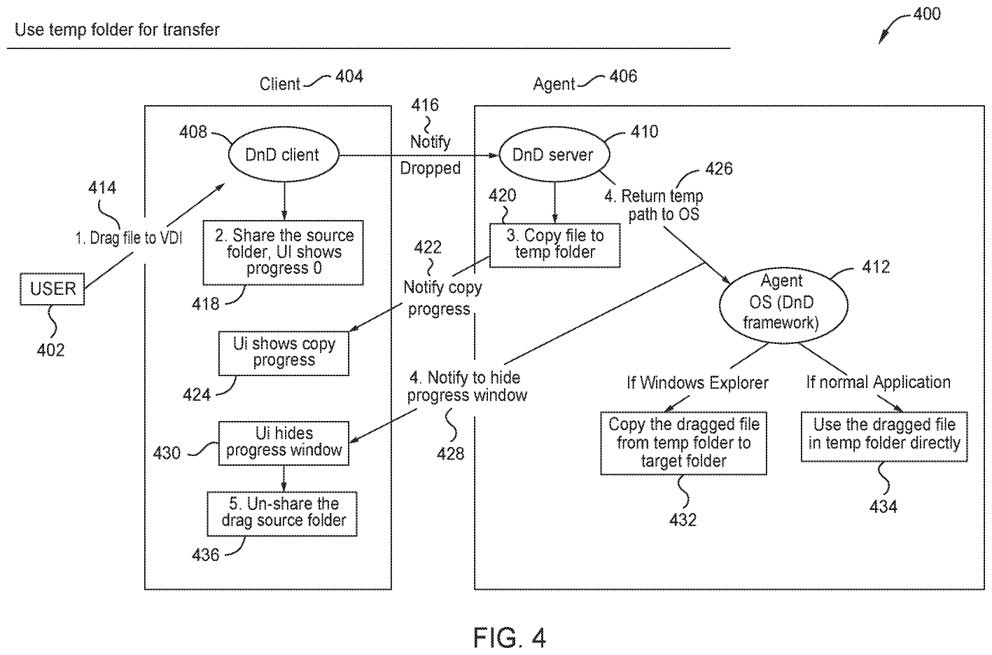

FIG. 4 is a diagram 400 illustrating a method for transferring a file or folder from a client to an agent using a temporary folder. A user 402, Client 404 (such as client device 104), and Agent 406 (such as VM 120) are illustrated. Client 404 comprises a DnD Client 408 in OS 132. Agent 406 comprises a DnD Server 410 in guest OS 122 and an Agent OS 412, such as guest OS 122. The steps illustrated in diagram 400 may be performed in any suitable order.

In this example, user 402 wants to drag and drop a file from client 404 to agent 406. At step 414, the user drags the file that the user wants to transfer from the client side to the target location on the agent side and then drops the file by releasing a mouse button. The file can be dropped into a file manager application (e.g., a file explorer such as Windows Explorer) on the remote side or into an application 126 running on the remote side. At step 416, DnD Client 408 notifies DnD Server 410 that a file has been dropped from Client 404 to Agent 406. This notification can be transmitted on the first channel, such as a control message channel. At step 418, Client 404 shares the source folder for the dragged file with agent 406 by CDR. Also, at this time the client UI on client device 104 shows user 402 that the progress is 0%.

At step 420, DnD Server 410 copies the source file to a temporary folder at agent 406. The file is transferred using a second channel, such as CDR. During this copy process, Agent 406 notifies Client 404 of the progress of the copy operation at step 422 using the control message channel. The UI at Client 404 shows the copy progress at step 424. After the copy is finished, DnD Server 410 returns the file path of the temporary folder to Agent OS 412 at step 426. At step 428, Client 404 is notified by Agent 406 to hide the progress window. At step 430, client UI hides the progress window.

If the file is copied to the file manager application at Agent 406, the method proceeds to step 432 where the dragged file is copied from the temporary folder to the target folder. If the file is copied to a remote application at Agent 406, the method proceeds to step 434 where Agent OS 412 uses the dragged file in the temporary folder directly. At step 436, Client 404 unshares the drag source folder.

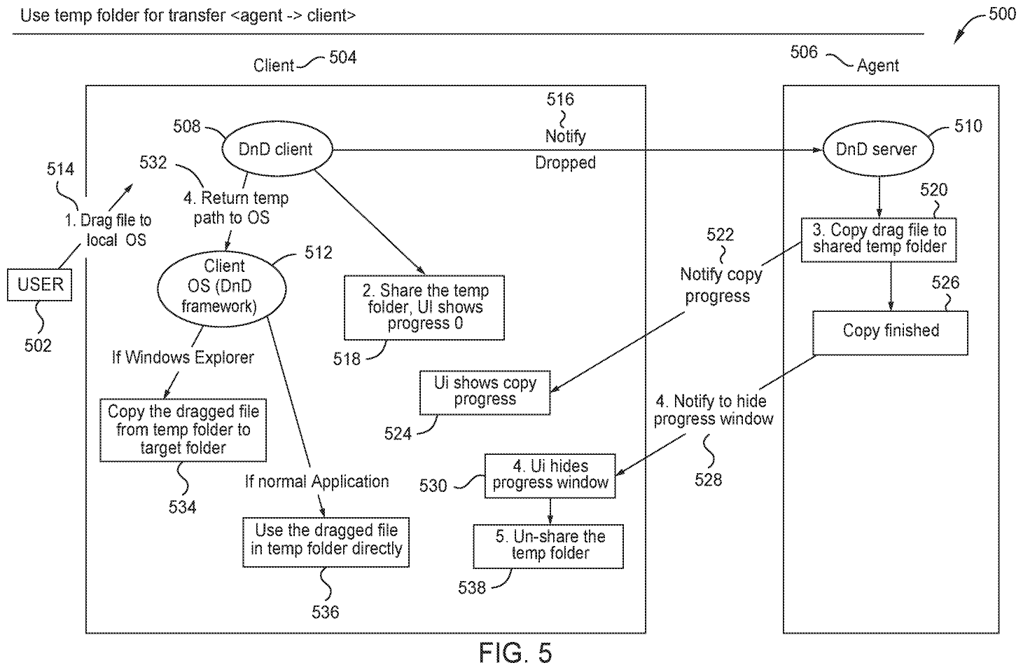

FIG. 5 is a diagram 500 illustrating a method for transferring a file or folder from an agent to a client using a temporary folder. A user 502, Client 504 (such as client device 104), and Agent 506 (such as VM 120) are illustrated. Client 504 comprises a DnD Client 508 and a Client OS 512 (such as OS 132). Agent 506 comprises a DnD Server 510 in guest OS 122. The steps illustrated in diagram 500 may be performed in any suitable order.

In this example, user 502 wants to drag and drop a file from Agent 506 to Client 504. At step 514, the user drags the file that the user wants to transfer from the remote side to the target location on the client side and drops the file. The file can be dropped in the client OS's file manager application or an application running in OS 132 on Client 504.

At step 516, DnD Server 510 is notified via the control message channel that a file has been dragged and dropped from Agent 506 to Client 504. At step 518, a temporary folder in Client OS 512 is shared by CDR, and the client UI shows an initial progress of 0%. At step 520, DnD Server 510 copies the drag source file to the shared temporary folder. During the copy process, Agent 506 notifies Client 504 of the copy process at step 522, and the client UI at client device 104 shows the copy progress at step 524.

At step 526, the copy is finished. Agent 506 notifies Client 504 to hide the progress window on the UI of client 504 at step 528, and the Client 504 UI hides the progress window at step 530. At step 532, DnD Client 508 returns the file path under the temporary folder to the Client 504 OS. If the file is copied to the file manager application, the method proceeds to step 534 where the dragged file is copied from the temporary folder to the target folder. If the file is copied to a remote application, the method proceeds to step 536 where Client OS 512 uses the dragged file in the temporary folder directly. At step 538, Client 504 unshares the temporary folder.

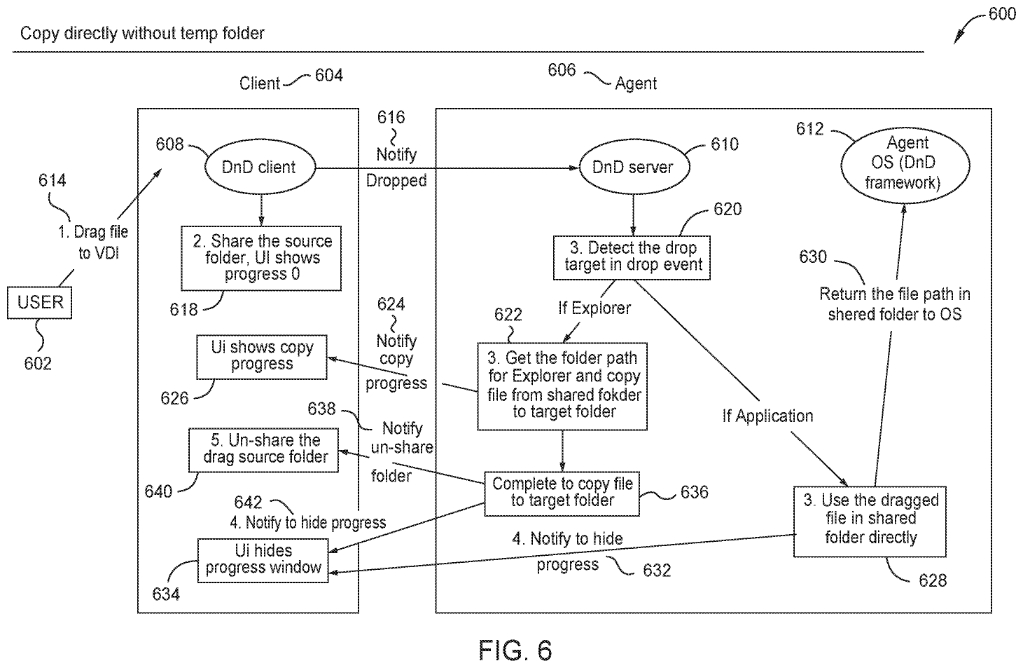

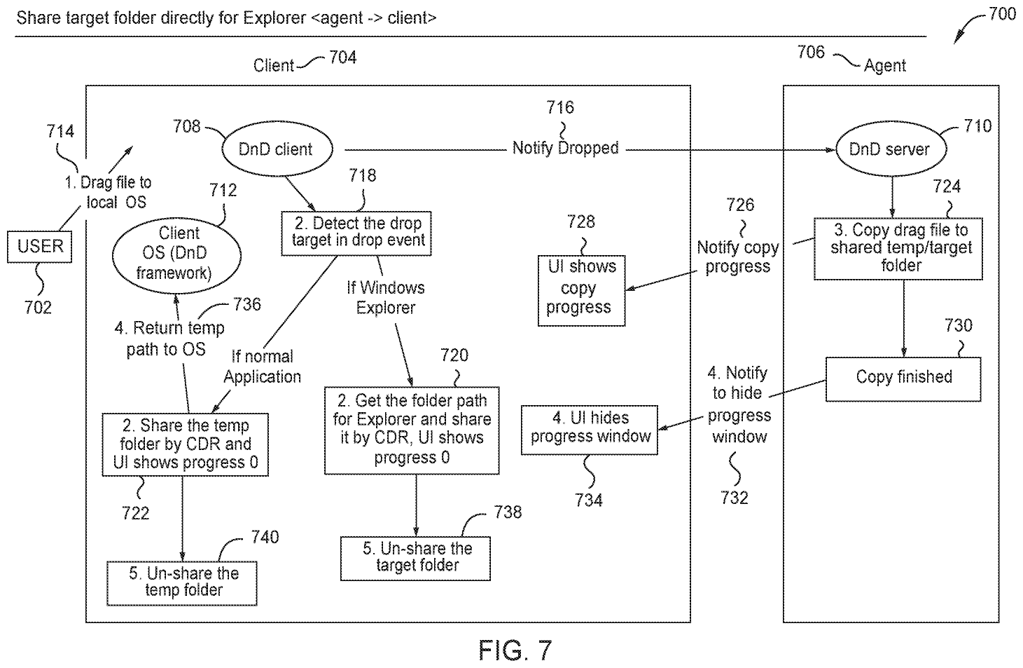

The two workflows described in FIGS. 4 and 5 copy the dragged file first to a temporary folder and then to a target folder. If the file that is copied is large, these two workflows need additional time to complete the two copies. The workflows described in FIGS. 6 and 7 below avoid the additional file copy operation.

FIG. 6 is a diagram 600 illustrating a method for transferring a file or folder from a client to an agent without using a temporary folder. A user 602, Client 604 (such as client device 104), and Agent 606 (such as VM 120) are illustrated. Client 604 comprises a DnD Client 608 in OS 132 of client 604. Agent 606 comprises an Agent OS 612 and a DnD Server 610 in Agent OS 612 (such as guest OS 122). The steps illustrated in diagram 600 may be performed in any suitable order.

In this example, user 602 wants to drag and drop a file from Client 604 to Agent 606. At step 614, the user drags the file that the user wants to transfer from the client side to the target location on the remote side and then drops the file at a representation of the target location in a user interface. The file can be dropped into the file manager application on the remote side or into an application 126 running on the remote side. At step 616, DnD Client 608 notifies DnD Server 610 that a file has been dropped from Client 604 to Agent 606. At step 618, Client 604 shares the source folder for the dragged file with Agent 606 by CDR. Also, at this time the client UI at client device 104 shows user 602 that the progress is 0%.

At step 620, DnD Server 610 detects the drop target from the notification information at step 616. If the drop target is a file manager application in agent OS 612, the method proceeds to step 622 where DnD Server 610 retrieves the folder path that the file manager application is pointing to and copies the drag source file at Client 604 from the shared folder to the target folder. In addition, at step 624 Client 604 is notified of the copy progress from Agent 606. At step 626, the Client 604 UI shows the copy progress.

If the drop target is an application on Agent 606 (such as application 126) instead of the file manager application, the method proceeds to step 628 where the dragged file is accessed in the shared folder directly. At step 630, DnD Server 610 returns the file path in the shared folder to Agent OS 612. In addition, Client 604 is notified in step 632 to hide the copy progress UI window in step 634.

Returning to the situation where the drop target is the file manager application, the copy operation in step 622 is finished at step 636. Client 604 is notified at step 638 to unshare the drag source folder. At step 640, Client 604 unshares the folder. At step 642, DnD Server 610 notifies Client 604 to hide the progress UI window. Therefore in this workflow, the dragged and dropped file is copied directly to Agent 606 without using a temporary folder.

FIG. 7 is a diagram 700 illustrating a method for transferring a file or folder from an agent to a client without using a temporary folder. A user 702, Client 704 (such as client device 104), and Agent 706 (such as VM 120) are illustrated. Client 704 comprises a Client OS 712 (such as OS 132) and a DnD Client 708 in Client OS 712. Agent 706 comprises a DnD Server 710 in an Agent OS such as guest OS 122. The steps illustrated in diagram 700 may be performed in any suitable order.

In this example, user 702 wants to drag and drop a file from Agent 706 to Client 704. At step 714, the user drags the file that the user wants to transfer from the remote side to the target location on the client side and drops the file at a representation of the target location in a user interface. The file can be dropped in client OS 712's file manager application or an application on Client 704.

At step 716, DnD Server 710 is notified via the control message channel that a file has been dragged and dropped from Agent 706 to Client 704. In the drop event, DnD Client 708 detects the drop target at step 718. If the drop target is a file manager application in OS 132, DnD Client 708 retrieves the folder then the file manager application is pointing to, then shares the target folder with Agent 706 via CDR as shown in step 720. If the drop target is an application, then in step 722 a temporary folder in the client OS is shared via CDR and the client UI at client device 104 shows the progress is 0%.

Next, DnD Server 710 copies the dragged source file to the shared temporary or target folder in step 724. In step 726, Client 704 is notified of the copy progress by DnD Server 710, and in step 728 the client UI shows the copy progress.

The copy operation is finished at step 730. DnD Server 710 notifies Client 704 to hide the progress window in step 732, and the client UI hides the progress window in step 734. If the drop target is an application, DnD Client 708 returns the shared temporary file path to Client OS 712 in step 736.

If the drop target is the file manager application, the Client 704 drop target folder is unshared in step 738. If the drop target is an application, the temporary folder is unshared in step 740.

When dragging an object from a remote desktop or remote application, such as application 126, to a client device 104, the DnD feature needs to detect whether a real DnD operation is occurring. To implement this capability, one embodiment uses hidden detection windows in guest OS 122. For example, a drag detection window for VDI is used to detect whether the user is performing a DnD operation from the remote desktop to client device 104. In another example, a drag detection window for a remote application 126 is used to detect whether a user is performing a DnD operation from the remote application 126 to client device 104. Because remote desktops may use different coordinate systems than remote applications, separate detection windows may be used to detect the different types of drag operations in an embodiment. Additionally, a hidden message window can be used to deal with internal messages sent from the detection window during DnD operations.

When the user attempts to drag a file from a remote VM 120 to client device 104, an “ungrab” operation has to be handled. In one embodiment, the steps to perform an ungrab operation are as follows. First, a RMKS (remote mouse, keyboard, screen) process in OS 132 at client device 104 detects the ungrab attempt and sends an Ungrab command to the remote VDI agent 124. This command can be sent via the control message channel in one embodiment.

VDI client 134 receives notification of the Ungrab command and sends a DnD RPC (remote procedure call) message (i.e., a DnD command message) to VDI agent 124 to detect the DnD. VDI agent 124 then moves the detect window to the target positon and begins a valid DnD process. VDI agent 124 sends a DnD RPC message to VDI client 134 to notify “Drag Enter” and VDI client 134 sends a command such as “allowButtonDownMotionUngrab=true” to trigger the ungrab action. VDI client 134 then starts a new thread to begin the client side DnD operation.

For remote applications 126, a seamless window captures the mouse events by itself instead of the RMKS process, so the remote application 126 also needs to handle the “ungrab.” First, the remote application 126 sets a “Dragging” flag when “Mouse Move” is detected with any mouse button being currently held down by a user. Then, the seamless window determines whether the action is a drag-in or a drag-out. If it is a drag-out, application 126 notifies VDI agent 124 to move a detection window and start the agent-to-client DnD process.

In some embodiments, the data transfer for the DnD process can happen on either the CDR channel or the control message channel. For example, if the object to be transferred is small, the object can be sent on the control message channel along with the drag and drop commands. If a larger object is being sent, the CDR channel can be used which is suitable for large data transfers. In addition, in some embodiments data size control capability is provided for each channel.

In some embodiments, when files or other objects are being copied from VDI client 134 to VDI agent 124, a parent folder where the dragged files/objects are located at client device 104 is shared to VDI agent 124. However, for security reasons, it may not be desirable for other files and subfolders in the parent folder to be shown to or accessed by VDI agent 124. To provide security, an access rule can be defined, such as a whitelist of files/objects/subfolders/etc. that VDI agent 124 is allowed to access. If the request from VDI agent 124 is not for an object in the whitelist, the request is rejected by VDI client 134. In addition, when VDI agent 124 queries information for the shared folder, the information for the objects not in the whitelist can be filtered by VDI client 134 so that VDI agent 124 does not know of their existence.

While support for dragging and dropping a single format of data, such as files, is described above, embodiments described herein also support dragging and dropping mixed formats of data. For example, text, rich text, images, and other content can also be dragged and dropped, either individually or mixed together. In one embodiment, when this content is dragged and dropped, both the control message and the data are transmitted through the control message channel. In another embodiment, control messages are transmitted through the control message channel and files are transmitted through the CDR channel.

With support of DnD for multiple formats (text, images, etc.), DnD controls for specific formats are implemented in some embodiments. That is, settings can be implemented that allow filtering of the various formats. As a default, all formats can be allowed to be dragged and dropped in both directions. A user interface at client device 104 allows a user to enable or disable DnD for each specific format. The user could also enable or disable DnD in one direction or both directions for any particular format. The user interface allows a user to fully customize the options for size and format restrictions on dragged and dropped objects.

Similar to the format controls, a size control can be implemented via the user interface at client device 104. If dragged content exceeds a preset size threshold, the drag operation can be abandoned. An error message is displayed to the user notifying the user of the abandoned operation in one embodiment. In other embodiments, the dragged content can be truncated or filtered, so that a portion of the DnD is completed that does not exceed the size threshold. For example, some of the files or other content will be transmitted, up to the size threshold, while the rest of the files or content will not be transmitted. The user interface can allow the user to set the size threshold to any appropriate value, whether it is in bytes, kilobytes, megabytes, or gigabytes. The user can also set no size threshold. Size thresholds can also be set separately for different file formats. For example, a first size threshold can apply to data in text format, while a second size threshold can apply to data in image format. Any number of size thresholds can be implemented to apply to the various data formats.

Negotiation and control of size thresholds and format restrictions between a VDI client 134 and an agent, such as VDI agent 124, can be implemented in numerous ways. Negotiation and control includes three aspects. VDI agent 124 and VDI client 134 retrieve the controls from a registry or configuration separately and then negotiate with one another to implement the final capability. Then the negotiated capability is set in the appropriate component, either VDI client 134 or VDI agent 124 or both. Finally, the checkpoint to implement the control is added. In one embodiment, the checkpoints can be placed in a DnD Drop Target Object on the client or agent side (such as DnD Drop Target 214 and/or DnD Drop Target 228 described above with respect to FIGS. 2A and 2B). The checkpoint can be implemented when the drag is initiated in one embodiment.

Size controls are implemented and applied based on the format of the dragged objects as described above. If a user drags a similar type of data from different applications, the format of the data may be different. For example, if a user drags an image from Microsoft® Paint, the data format in OLE is image. Conversely, if the same image is inserted into a Microsoft® Word document and then dragged, the data formats in OLE are image and HTML. If the image is dragged from a WordPad document, the format is Rich Text.

In addition, for the same piece of content, the size on disk of the content and the size of the content stored in OLE may be different. Different image formats (JPEG, BMP, PNG, etc.) also result in different sizes on disk. Because clients and agents from embodiments described herein retrieve data from OLE for DnD operations, the clients and agents do not have information regarding the source of the data (i.e., an image or a document) and also do not have information regarding the format of the data stored on the disk. Also, the same object may have different sizes in different operating systems.

Because of this unknown information, size controls are performed on the format that OLE provides in one embodiment. The actual format of the data outside of OLE is not considered. In addition, in one embodiment herein, the size controls are implemented based on the size of the data stored in a clipboard structure instead of the size stored on the disk or the size represented by OLE.

A number of strategies may be implemented to implement size controls. For example, if an image exceeds the size threshold, the entire image is abandoned. A user can be notified via a user interface on client device 104 if the DnD operation is abandoned in one embodiment. As another example, for Rich Text, HTML, and other formats, plain text is provided along with the original format for a drag operation. If the dragging size exceeds the size threshold, the formatting and style information is discarded, and the plain text is truncated according to the size threshold (if necessary) and then copied to the drop target.

As a third example, if multiple formats are retrieved from OLE during a DnD operation, the formats can be checked one by one by priority. In one embodiment, text has a higher priority than images, which in turn have a higher priority than HTML. The size of each format is calculated to see if it should be abandoned based on the leftover size remaining underneath the threshold after subtracting the total size of the higher priority formats. Any suitable priority of formats may be used in other embodiments.

For DnD of files and folders, size control introduces other considerations. For data formats other than files or folders, data is stored in OLE and the size can be derived from OLE data. For files and folders, only the path names of the files and folders are stored in OLE. Therefore the size has to be queried separately, which may take a long time if the user dragged and dropped a large number of files or folders. Also, if the size exceeds the size threshold, the DnD can be rejected or partially completed. Because of these different considerations, three implementations are described herein.

First, the size control can occur after the drag action is performed, whereby some of the files and/or folders are copied up to the size threshold. Once the size threshold is reached, the remaining files and/or folders are not copied. A second solution is to implement size control just before file copying, and some of the files and/or folders are copied up to the size threshold. A third solution is to implement size control just before file copying, and the DnD operation is rejected and a warning is issued to the user if the size exceeds the threshold. Under each of these three implementations, the user experience and performance of the system may differ. Therefore any of the implementations may be suitable to employ depending on the desired application.

In some embodiments, content may be dragged and dropped between different operating systems. For example, a guest OS 122 may comprise a Windows operating system and an OS 132 at a client device 104 may comprise a Mac operating system. These operating systems have different mouse coordinate systems. When objects are dragged between a client and an agent, the mouse point should be converted, so that the object is dragged to the correct destination.

For Mac OS, the origin of the mouse coordinates is the bottom left corner of the display. For Windows OS, the origin is the upper left corner. For a client using Mac OS, the origin point is changed to the upper left corner.

If a user has more than one monitor, the origin point is also different between Mac OS and Windows OS. For Windows OS, one of the monitors is set as the main monitor and the origin point of the overall system is the upper left corner of the main monitor. For Mac OS, the origin point is the bottom left corner of all the monitor screens, no matter which one is the main monitor. That difference is accounted for when the origin point is changed for a DnD operation.

In some implementations, feedback on the DnD operation (such as accept/reject) is generated only after the data is received on the target side. Therefore, if the data size is large, a long time can pass before the feedback is received at the source side. In one embodiment, to accelerate feedback, the data type is sent first and an empty data object is created on the drop side with a specific data type (text, rich text, image, etc.). Then, the target OLE object (such as DnD drop Target 228 in FIGS. 2A and 2B) can send feedback based on the empty data object. This implementation can improve the performance of the feedback operation.

It should be understood that, for any process described herein, there may be additional or fewer steps performed in similar or alternative orders, or in parallel, within the scope of the various embodiments, consistent with the teachings herein, unless otherwise stated. In embodiments described herein, a technical solution is provided for a technical problem. In one example embodiment, the technical problem is that a drag and drop function is not supported in existing virtual desktop environments. Therefore, a user cannot easily drag and drop files or folders from a client to a remote computer or vice versa. An example technical solution presented herein is to use two channels to implement redirection of an operating system event: a first channel to transfer the drag and drop workflow commands between the client and the remote computer and a second channel to transfer the dragged object. In addition, various size and format controls can be implemented on the dragged objects.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of transferring a file or object between a virtualized desktop infrastructure (VDI) client running on a client device and a remote virtual machine (VM), wherein the remote VM is connected to the VDI client through a network, the method comprising:
receiving, at the client device, an input corresponding to a drag and drop operation of an object between a local storage of the client device and a remote desktop displayed at the client device, the remote desktop running on the remote VM;
based on the input, transferring one or more commands corresponding to the drag and drop operation from the client device to the remote VM or from the remote VM to the client device via a first channel; and
based on the input, transferring the object from the client device to the remote VM or from the remote VM to the client device via a second channel.

2. The method of claim 1, further comprising, based on the input, transferring the object from the client device to the remote VM or from the remote VM to the client device via the second channel when the size of the object is above a threshold.

3. The method of claim 1, further comprising, based on the input, transferring the object from the client device to the remote VM or from the remote VM to the client device via the first channel when the size of the object is below a threshold.

4. The method of claim 1, further comprising:
sending progress data from the remote VM to the client device via the first channel while the object is transferred.

5. The method of claim 1, wherein receiving the input comprises detecting whether the object is transferred to the remote desktop at the remote VM or to an application at the remote VM using two or more detection windows.

6. The method of claim 1, wherein the object is transferred to a temporary folder at the remote VM and then copied to a target folder.

7. The method of claim 1, wherein a format of the object is detected during the drag and drop operation, and transferring the object is blocked based on the format of the object.

8. The method of claim 1, wherein transferring the object from the client device to the remote VM or from the remote VM to the client device comprises transferring a portion of the object when the size of the object is above the threshold.

9. The method of claim 1, wherein the object comprises two or more data formats, and data in each of the data formats are transferred from the client device to the remote VM or from the remote VM to the client device.

10. The method of claim 1, wherein transferring the object from the client device to the remote VM or from the remote VM to the client device via a second channel when a size of the object is above a threshold further comprises creating an empty data object at a target destination before transferring the object.

11. A non-transitory computer-readable medium comprising instructions to be executed in a processor of a computer system, the instructions when executed in the processor cause the computer system to carry out a method of transferring a file or object between a virtualized desktop infrastructure (VDI) client running on a client device and a remote virtual machine (VM), wherein the remote VM is connected to the VDI client through a network, the method comprising:
receiving, at the client device, an input corresponding to a drag and drop operation of an object between a local storage of the client device and a remote desktop displayed at the client device, the remote desktop running on the remote VM;
based on the input, transferring one or more commands corresponding to the drag and drop operation from the client device to the remote VM or from the remote VM to the client device via a first channel; and
based on the input, transferring the object from the client device to the remote VM or from the remote VM to the client device via a second channel.

12. The non-transitory computer-readable medium of claim 11, further comprising, based on the input, transferring the object from the client device to the remote VM or from the remote VM to the client device via the second channel when the size of the object is above a threshold.

13. The non-transitory computer-readable medium of claim 11, further comprising, based on the input, transferring the object from the client device to the remote VM or from the remote VM to the client device via the first channel when the size of the object is below a threshold.

14. The non-transitory computer-readable medium of claim 11, further comprising:
sending progress data from the remote VM to the client device via the first channel while the object is transferred.

15. The non-transitory computer-readable medium of claim 11, wherein receiving the input comprises detecting whether the object is transferred to the remote desktop at the remote VM or to an application at the remote VM using two or more detection windows.

16. The non-transitory computer-readable medium of claim 11, wherein the object is transferred to a temporary folder at the remote VM and then copied to a target folder.

17. The non-transitory computer-readable medium of claim 11, wherein a format of the object is detected during the drag and drop operation, and transferring the object is blocked based on the format of the object.

18. The non-transitory computer-readable medium of claim 11, wherein transferring the object from the client device to the remote VM or from the remote VM to the client device comprises transferring a portion of the object when the size of the object is above the threshold.

19. The non-transitory computer-readable medium of claim 11, wherein the object comprises two or more data formats, and data in each of the data formats are transferred from the client device to the remote VM or from the remote VM to the client device.

20. The non-transitory computer-readable medium of claim 11, wherein transferring the object from the client device to the remote VM or from the remote VM to the client device via a second channel when a size of the object is above a threshold further comprises creating an empty data object at a target destination before transferring the object.
